(19) United States
(12) Patent Application Publication
(10) Pub. No.: US 2026/0303394 A1
(43) Pub. Date: Oct. 1, 2026

(54) SYSTEMS AND METHODS FOR RECORDING AND PRESENTING SHARED CONTENT DURING A VIRTUAL MEETING

(71) Applicant: Adeia Guides Inc., San Jose, CA (US)

(72) Inventors: Tao Chen, Palo Alto, CA (US); Dhananjay Lal, Englewood, CO (US)

(21) Appl. No.: 19/094,264

(22) Filed: Mar. 28, 2025

(51) Int. Cl. H04L 12/18

(52) U.S. Cl. CPC H04L 12/1831; H04L 12/1822

(57) ABSTRACT

Methods and systems are presented herein for presenting previously recorded content. A virtual meeting server may determine that a plurality of presented content is shown simultaneously during a virtual meeting. The virtual meeting server may record each of the plurality of presented content which also includes individually encoding and packaging each of the plurality of presented content and at least one primary video stream. The virtual meeting server receives a request to replay content of the virtual meeting. Based on receiving the request to replay the content of the virtual meeting, the virtual meeting server provides a meeting recording including the at least one primary video stream and a recording of each of the plurality of presented content. The meeting recording enables presentation of the first presented content synchronously with respect to a time at which the first presented content was shared relative to at least one primary video stream.

### BACKGROUND

This disclosure is directed to systems and methods for recording and presenting content during a virtual meeting, including content which may have been shared but not presented during a virtual meeting.

### SUMMARY

Multiple participants may be involved in a virtual meeting. A server managing a virtual meeting may be built upon different types of architectures to determine how each participant in the virtual meeting receives content. In some implementations, a virtual meeting may be built on top of a multipoint control unit (MCU). An MCU is a server that receives, mixes, and transmits content to and from different devices participating in a virtual meeting. Each device participating in the virtual meeting essentially receives the same, single stream. For example, in a meeting with three participants, each with their own device, a first device may upload data at a high resolution, a second device may upload data at a high resolution, and a third device may upload data at a low resolution. An MCU would transmit the same stream to each device, so the same content at the same resolution is presented to each device.

In some implementations, a virtual meeting may be built on top of a selective forwarding unit (SFU). An SFU is a server that receives content from each device participating in a virtual meeting, determines what content should be transmitted to each device, and transmits possibly different content to each device. For example, in a meeting with three participants, each with their own device, a first device may upload data at a high resolution, a second device may upload data at a high resolution, and a third device may upload data at a low resolution. An SFU may transmit (e.g., during a downlink procedure) a high-quality stream to the first device, a high-quality stream to the second device, and a low quality stream to the third device. An SFU may transmit different qualities to different devices during downlink. That is, in implementations where a virtual meeting is built on top of an SFU, each device participating in the virtual meeting may receive a different stream, resulting in different viewing experiences for participants of different devices.

Virtual meetings may be recorded (e.g., for the purpose of later review). When a virtual meeting is recorded, typically only the content received at the device which is responsible for recording the virtual meeting is saved. For example, in a meeting with three participants, if a first device of a first participant is responsible for recording, then the content that first device receives will be the content that is recorded. If a second device of a second participant or a third device of a third participant in the meeting receives higher quality content, then the recording of the virtual meeting may still be in lower quality if the first device is responsible for recording. Hence, depending on whether a virtual meeting is built on top of an MCU or an SFU architecture, a recording of a virtual meeting may be in lower quality than expected.

Furthermore, multiple participants may simultaneously share one or more screens during a virtual meeting. The ability to simultaneously share different screens may be useful when different participants want to compare different documents, brainstorm an idea, or collaborate on a project. It may be desirable to record a virtual meeting where multiple screens are shared. For example, a meeting may include five participants. A first user of a first device may share a first screen, a second user of a second device may share a second screen, and a third user of a third device may share a third screen. A display of a fourth device used by a fourth user may display the first shared screen and the second shared screen (e.g., because the first and the second shared screens are the screens of interest to the fourth user). During the same meeting, a display of a fifth device used by a fifth user may display the first shared screen and the third shared screen (e.g., because these are the screens of interest to the fifth user). If during the virtual meeting the content displayed at the fourth device is recorded, then the recording of the virtual meeting may not include content which was displayed on other displays. Moreover, in some implementations, only certain users (e.g., the host) may be able to record the virtual meeting (i.e., other users may not have permissions allowing them to record the virtual meeting). For example, the recording may only contain the content shared from the first shared screen and the second shared screen, but not the third shared screen. As a result, content which may have been relevant during the virtual meeting (e.g., at least to certain users) may not be present in the recorded virtual meeting, negatively impacting a reviewing experience.

In other words, because virtual meetings are typically recorded at or from the point of view of a user client (e.g., even if the recordings are later stored in a cloud server), the recordings will only include content visible at the recording device, resulting in recordings that may omit content that was shared and available during the virtual meeting. When a user later views this recording, the user will not be able to view content that was shared but not shown at the recording device. Moreover, the underlying infrastructure (e.g., MCU or SFU architecture) may influence the quality of the resulting recording.

In some implementations, a recording of a live virtual meeting may include audio from every participant. While an audio may include the input from different participants, it may still be difficult to comprehend the content of a meeting without a corresponding shared screen to view in parallel. For example, if during a virtual meeting a participant is discussing a figure with specific components which are displayed on a screen, but the screen displaying the components does not appear in a recording, then the audio recorded during the live virtual meeting may be inadequate by itself in order to understand the figure discussion.

In some implementations, when a recording of a live virtual meeting is played back, it may be possible to access the transcript corresponding to the live virtual meeting. Transcripts, however, may not include correct transcriptions of certain words which were said during the live virtual meeting. Moreover, transcripts may be inaccurate if there is background noise during the live virtual meeting which may prevent a transcription software from accurately transcribing an audio into text.

Due to the limitations of some implementations when recording live virtual meetings, it is desirable to present a method and system which enables the ability to view any of the screens, windows, or other forms of content shared during a live virtual meeting, including content shared but not presented on a display which was responsible for recording the live virtual meeting.

To help address these problems, the systems, methods, and apparatuses disclosed herein are configured to enable the presentation of any presented content that was shared during a virtual meeting, regardless of whether the presented content was visible to other participants. Presented content may include any of a displayed screen, window, slide show, or any suitable form of content.

Systems and methods disclosed herein enable presented content that was shared by a participant, but maybe not shown on a certain device, to be viewed in the recording of the virtual meeting. In some embodiments, a virtual meeting server may determine that a plurality of presented content is shared simultaneously during a virtual meeting. Each of the plurality of presented content is shown on at least one device of a plurality of devices. For example, if presented content includes only screens, a first participant may view a first screen and a third screen. A second participant may view the same first screen and a second screen. The virtual meeting server may determine that at least one of the first, second, or third screens are being shared to at least one participant during the virtual meeting.

In some embodiments, the virtual meeting server may record each of the plurality of presented content. When the virtual meeting server records each presented content, the virtual meeting server individually encodes and packages each presented content. The plurality of presented content includes a first presented content shared at a first time during the virtual meeting and shown at a particular device of the plurality of devices and a second presented content shared at the first time during the virtual meeting but not shown at the particular device such that the second presented content is different from the first presented content. For example, the virtual meeting server may record each of the contents presented on a first, second, and third device, regardless of whether content displayed on one device was presented or not presented to the participant recording the virtual meeting. When recording, each of the first, second, and third device's contents are individually encoded and packaged at the virtual meeting server to be later provided in a meeting recording as further discussed below. In addition, the virtual meeting server may individually package and encode at least one primary video stream associated with a respective device. For example, a video stream (e.g., a webcam video) may be associated with each device presenting content. Each video stream may be individually packaged and encoded. In some embodiments, the plurality of the primary video streams may be packaged and encoded as a composite primary video stream recording.

In some embodiments, the virtual meeting server may receive a request to replay content of the virtual meeting and, based on receiving the request to replay the content of virtual meeting, provide a meeting recording which includes at least one primary video stream and a recording of each item of presented content. Furthermore, the meeting recording enables presentation of presented content in a manner that is synchronized with respect to a time at which the certain presented content was shared relative to at least one primary video. For example, during the virtual meeting in real-time, a first screen may be shared and presented on a first device having its content recorded, and a second screen may be shared but not presented on the first device (e.g., the second screen is presented only on a second device). As previously discussed above, content from both devices are individually packaged and encoded at the virtual meeting server; as a result, the virtual meeting server provides each individually packaged and encoded content back to a client when requested, enabling the playback of any content which was presented during the virtual meeting. That is, following the previous example, the meeting recording enables presentation of the any presented content during playback of the virtual meeting, even if certain items of presented content were not shown on a particular device having its contents recorded during the virtual meeting in real-time.

Furthermore, a primary video stream may be shown in addition to whatever presented content is shown during playback in a synchronized manner. A webcam stream of a given display corresponding to a certain time may be shown together with certain presented content corresponding to the same time. For example, a webcam stream corresponding to the timestamps of 3:05-7:10 may be shown together with certain presented content also corresponding to the timestamps of 3:05-7:10.

In some embodiments, a virtual meeting server may determine, for each of the plurality of presented content, a respective relevance metric. The virtual meeting server may determine the most relevant presented content of the plurality of presented content based on the respective relevance metrics, and show, within the meeting recording, an indication that the most relevant presented content has a highest relevance score. For example, during a virtual meeting discussing an invention disclosure, a first presented content may include a slide show with illustrative figures of the invention, and a second presented content may include supplemental notes regarding the invention. The virtual meeting server may determine that the first presented content including illustrative figures of the invention has a higher relevance metric compared to the second screen displaying supplemental notes regarding the invention. As a result, within the meeting recording for the virtual meeting, the first presented content including illustrative figures of the invention may be shown with a highlighted border, a larger presentation compared to other presented content, or any suitable indication that the first presented content has the highest relevance metric.

In some embodiments, a virtual meeting server may determine, for each of the plurality of presented content, a respective relevance metric by performing a visual or semantic analysis. The virtual meeting server may perform, for a certain time point or period in the virtual meeting, at least one of a visual analysis or a semantic analysis for a particular presented content. Based at least in part on at least one of the visual analysis or the semantic analysis, the virtual meeting server may determine a context corresponding to the particular presented content. The virtual meeting server may determine a context corresponding to the entire meeting at the certain point in time (e.g., based at least in part on the audio of the virtual meeting which corresponds to the certain time point or period). The virtual meeting server may compare the context corresponding to the particular presented content and the context corresponding to the entire meeting to determine a relevance score for the particular presented content. For example, a first presented content may include figures of an invention and correspond to an audio which discusses the figures of the invention. The context of the entire meeting may be related to a discussion regarding the figures, so a comparison of the context of the entire meeting and the context of the first presented content may result in a higher relevance metric corresponding to the first presented content.

In some embodiments, a virtual meeting server may determine a content highlight for a particular presented content of the plurality of presented content. The virtual meeting server may receive a query indicating to show the particular presented content which corresponds to the content highlight and present the particular presented content. For example, one presented content of a plurality of presented content may include fiscal results for the first quarter of 2025 and therefore be associated with a content highlight corresponding to first quarter fiscal results. If the virtual meeting server receives a query to present “2025 early year fiscal results,” the virtual meeting server may show the presented content which included fiscal results for a first quarter of 2025.

In some embodiments, recordings for each of the plurality of presented content may be stored or streamed at a certain quality based on the respective relevance metric. A virtual meeting server may determine, for each of the plurality of presented content, a respective relevance metric, and stream each of the plurality of screens at a respective quality based at least in part on the respective relevance metric corresponding to the respective screen. In such embodiments, each of the plurality of presented content may may be stored at a highest quality but streamed at a different quality. For example, if a first presented content and a second shared content both have corresponding relevance metrics which are greater than a third shared content, the first shared content and the second shared may be streamed at 2160p resolution. Meanwhile, the third screen may be streamed at 720p resolution. All three of the first, second, and third presented content may be stored in the virtual meeting server at a highest available quality.

In some embodiments, during playback of a meeting screen recording, a shown (or highlighted) screen may switch depending on changes to relevance metrics for various presented content over time. A virtual meeting server may show a first presented content of the plurality of presented content recording during a first time if the server determines that a relevance metric corresponding to the first presented content at the first time is greater than a relevance metric corresponding to the second presented content at the first time. At a second later time, the virtual meeting server may determine that the relevance metric corresponding to the first presented content at the second time is less than the relevance metric corresponding to the second presented content at the second time. The virtual meeting server may then cause the second presented content to be presented instead of the first presented content during playback of the meeting corresponding to the second later time. For example, a first presented content may have a relevance metric of 95 at timestamp 1:00:00, and a second presented content may have a relevance metric of 5 at timestamp 1:00:00. The virtual meeting server may show the first presented content at timestamp 1:00:00 during playback of the meeting recording. If at timestamp 1:30:00 the first presented content has a relevance metric of 10 and the second presented content has a relevance metric of 90, then the virtual meeting server may cause the second presented content to be presented at the 1:30:00 timestamp during playback of the meeting recording.

In some embodiments, a virtual meeting server may enable the presentation of various combinations of presented content of a plurality of presented content. For example, during a first time in a virtual meeting, the virtual meeting server may determine that a first presented content is shared during the virtual meeting and shown to a particular device, a second screen is shared during the virtual meeting but not shown to the particular device, and that a third presented content is shared during the virtual meeting and shown to the particular device. The meeting recording may enable the presentation of any of the first presented content and second presented content simultaneously, the first presented content and the third presented content simultaneously, the second presented content and the third presented content simultaneously, or the first presented content, second presented content, and third presented content simultaneously at the first time during playback of the meeting recording.

In some embodiments, during playback of the meeting recording, a received instruction may override the current presentation or highlighting of one or more types of presented content. If a meeting recording is played, then a virtual meeting server may cause a first presented content to be shown based at least in part on the relevance metric corresponding to the first presented content (e.g., such that the relevance metric corresponding to the first presented content is the greatest out of any of the plurality of presented content). The virtual meeting server may receive an instruction, such as a user input request, to cause a second presented content to be presented (e.g., such that the second presented content has a lower relevance metric than the relevance metric corresponding to the first presented content). Based on the received instruction, the virtual meeting server may cause the second presented content (having the lower relevance score) to be shown instead or in addition to the first screen (having the higher relevance score). For example, in a virtual meeting discussing a chemical reaction, a first presented content may correspond to a video demonstration of the chemical reaction, and the second presented content may correspond to a document of the reactants of the chemical reaction. The first presented content may be displayed during playback of the meeting recording (e.g., because it was determined that the first presented content corresponds to a greater relevance metric than the second presented content). The virtual meeting server may receive an instruction to instead display the second presented content displaying the reactants of the chemical reaction, and therefore cause the second presented content to be shown instead of or in addition to solely the first presented content, despite the second presented content corresponding to a lower relevance metric compared to the first presented content.

In some embodiments, certain presented content may be determined to be mandatory. A virtual meeting server may determine that a first presented content is mandatory at some first time and that a second presented content is supplemental at the first time. The virtual meeting server may cause, during playback of the meeting recording, the first presented content to be displayed with an indication that the first presented content is mandatory. For example, in a virtual meeting discussing a generative language model, a first presented content may include input and output results of the generative language model, and a second presented content may be a terminal displaying the subroutines running while the generative language model is running. The virtual meeting server may determine that the first presented content is mandatory and therefore highlight the border of the presented content when shown on the meeting recording, cause the first presented content to be displayed as a full screen, or any other suitable indication that the first presented content is considered mandatory to the virtual meeting.

In some embodiments, the virtual meeting server may receive an instruction to display the second presented content, even though the first presented content is considered mandatory. The virtual meeting server may cause the second presented content to be presented with an indication that the second presented content is supplemental while simultaneously presenting the first presented content with an indication that the first presented content is mandatory. For example, the virtual meeting server may receive an instruction to display the second presented content (which is a terminal displaying the subroutines running while the generative language model is running), even though the second presented content is considered supplemental. The meeting recording may still present the second presented content and present an indication that the second presented content is supplemental (e.g., by showing the second presented content smaller in comparison to the first presented content on the display on which the meeting recording is being viewed) while simultaneously presenting the first presented content of the generative language model with an indication that it is mandatory.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a diagram illustrating how a meeting recording that enables viewership of any presented content during a virtual meeting is generated, in accordance with some embodiments of this disclosure;

FIG. 2 is a diagram illustrating how presented content may be streamed at different resolutions, in accordance with some embodiments of this disclosure;

FIG. 3 is a diagram illustrating how relevance metrics may be determined, in accordance with some embodiments of the disclosure;

FIG. 4 is a diagram illustrating how a content highlight may be queried and shown in a meeting recording, in accordance with some embodiments of this disclosure;

FIG. 5 is an example virtual meeting where some presented content may be considered supplemental, in accordance with some embodiments of the disclosure;

FIG. 6 is a diagram illustrating how presented content is shown in a meeting recording depending on whether the presented content is mandatory or supplemental, in accordance with some embodiments of the disclosure;

FIG. 7 is a block diagram of an illustrative user equipment (UE) device, in accordance with some embodiments of the disclosure;

FIG. 8 is a flow diagram of a method for generating a meeting recording which enables the presentation of any presented content which was shared to at least one display during a virtual meeting, in accordance with some embodiments of this disclosure; and

FIG. 9 is a flow diagram of a method for viewing a virtual meeting which enables the synchronous playback of any presented content and any primary video stream, in accordance with some embodiments of this disclosure.

The drawings are intended to depict only typical aspects of the subject matter disclosed herein, and therefore should not be considered as limiting the scope of the disclosure. Those skilled in the art may understand that the structures, systems, devices, and methods specifically described herein and illustrated in the accompanying drawings are non-limiting exemplary embodiments and that the scope of the present invention is defined solely by the claims.

### DETAILED DESCRIPTION

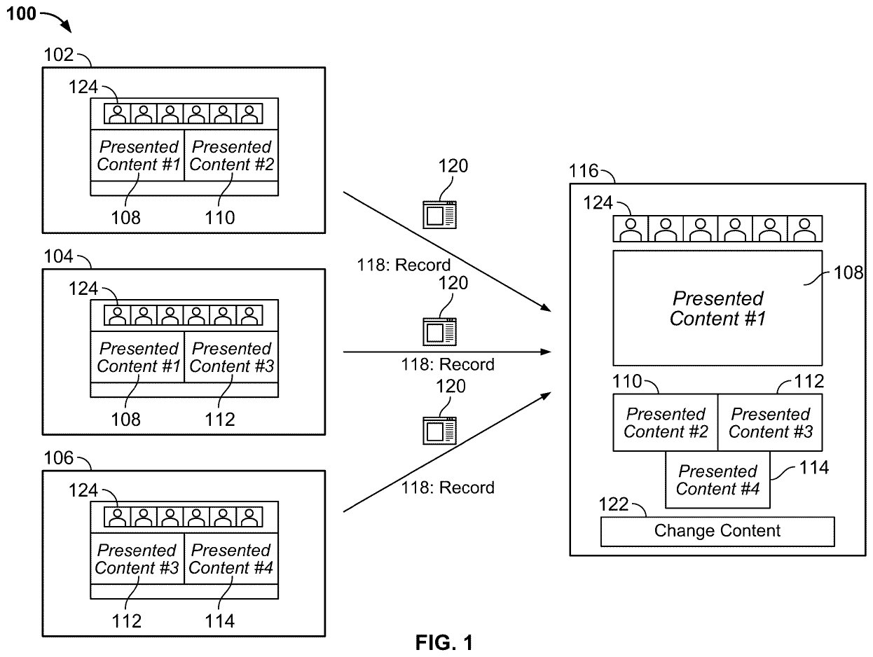

FIG. 1 is a diagram illustrating how a meeting recording that enables viewership of any presented content during a virtual meeting is generated, in accordance with some embodiments of this disclosure. As previously discussed above, when a virtual meeting is recorded, typically only content from one display may be viewed in the resulting recording. The one display may be the display that initiates the recording (hereafter referred to as a host display). In diagram 100, a virtual meeting is managed by virtual meeting server 120. Virtual meeting server 120 enables the generation of meeting recording 116 such that meeting recording 116 enables viewership of any of presented content 108-114. Virtual meeting server 120 may incorporate one or more features of an MCU architecture, SFU architecture, or any suitable virtual meeting architecture.

In diagram 100, display 102, display 104, and display 106 each are involved in a virtual meeting. Each of the displays show content which may be relevant to a particular user of the corresponding display. For example, display 102 shows first presented content 108 and second presented content 110; display 104 shows first presented content 108 and third presented content 112; and display 106 shows third presented content 112 and fourth presented content 114. Each display in diagram 100 shows list of participants 124, but list of participants 124 need not be shown (e.g., if virtual meeting server 120 is not hosting a video conference). List of participants 124 may include a primary video stream associated with each display (or any other suitable device). In the context of FIG. 1, list of participants 124 may include at least a primary video stream corresponding to display 102, a primary video stream corresponding to display 104, and a primary video stream corresponding to display 106.

Any content presented by any of displays 102-106 may be any of a screen, window, power point, set of notes, drawing, application, or any suitable form of media. For example, first presented content 108 may be a shared screen, second presented content 110 may be a power point, third presented content 112 may be a computer window, and fourth presented content 114 may be an integrated development environment from a programming application. Furthermore, any of displays 102-106 may be a computer monitor, extended reality (XR) device, augmented reality (AR) device, television, phone screen, or any suitable viewing medium. For example, display 102 may be a computer monitor, display 104 may be an XR device, and display 106 may be a phone screen.

In diagram 100, virtual meeting server 120 receives an instruction to record a meeting that includes displays 102-106. The instruction may originate from any one of displays 102-106. For example, circuitry coupled to display 102 may transmit an instruction to initiate a recording of a virtual meeting that includes displays 102-106. When virtual meeting server 120 receives the instruction, virtual meeting server 120 initiates process 118 to start a recording to generate meeting recording 116. The instruction to initiate process 118 need only originate from one device (e.g., any of displays 102-106). In other words, only one recording request needs to be received by virtual meeting server 120 to initiate process 118. During the virtual meeting, any of present content 108-114 may be received by any of displays 102-106 (or any other suitable client device).

During process 118, any presented content 108-114 shown on any display and a primary video stream associated with a respective display may be individually packaged and encoded. That is, each of presented content 108-114 and a video stream associated with a display are both packaged (e.g., into a compressed version) and encoded (e.g., into a signal to be transmitted to virtual meeting server 120 for further processing) in a manner that allows for synchronization. For example, virtual meeting server 120 may be configured to link a given item of presented content to a corresponding video stream (e.g., via a pointer). As such, when presented content is shown in meeting recording 116, the corresponding video stream may be shown in addition to the presented content such that both the presented content and the video stream are shown synchronously.

A primary video stream may be a webcam video associated with a particular display. For example, a first webcam may be associated with display 102, a second webcam may be associated with display 104, and a third webcam may be associated with display 106. In some embodiments, video meeting server 120 may be configured to generate a composite primary video stream recording which includes the primary video streams received from each client (e.g., each participant participating in the virtual meeting). The composite primary video stream recording may be delivered to each client in the virtual meeting. In some embodiments, video meeting server 120 may record and store each primary video stream separately (e.g., in a manner that enables time-synchronized playback of primary video streams and further enables the viewing of any recording of the entire virtual meeting). In some embodiments, virtual meeting server 120 may record and store a single composite video including the primary video streams. In any event, the video stream from each webcam may be later accessed and shown in meeting recording 116 (e.g., similar to the manner in which list of participants 124 is shown on any of displays 102-106 or such that any combination of participants from list of participants 124 are shown).

Virtual meeting server 120 manages the process for recording (i.e., individually packaging and encoding) each of content 108-114 and associated video streams. Virtual meeting server 120 may be further configured to associate certain video streams with certain presented content. As a result, for example, when presented content 108 is shown during meeting recording 116 at a first time, the primary video stream associated with device 102 may also be shown in a synchronized manner. Ultimately, when virtual meeting application 120 receives an indication to complete or otherwise no longer record the virtual meeting, meeting recording 116 may be generated.

Meeting recording 116 provides several functionalities. During the course of the virtual meeting, at a first time, display 102 may show content 108 and content 110. Third presented content 112 may be shown on display 104 at the first time while display 102 is only showing first content 108 and second presented content 110. Even if circuitry coupled to display 102 transmits an instruction to virtual meeting server 120 to initiate a recording of the virtual meeting (or if display 102 is the host display), meeting recording 116 enables the presentation of third presented content 112 at the first time during playback.

For example, at timestamp 5:15 during the virtual meeting, only first presented content 108 and second presented content 110 were shown on display 102 (e.g., the host display). Simultaneously at timestamp 5:15, the first presented content 108 and third presented content 112 may be shown on display 104 (e.g., a participant display). Even if display 102 transmits the instruction to virtual meeting application 120 to initiate the meeting recording, third presented content 112 may be presented in meeting recording 116 at the 5:15 timestamp. That is, even though the recording was initiated by the host (e.g., host display 102), and the host display did not show presented content 112 during the live meeting, the recording of the meeting may enable presentation of presented content 112 (and/or any other content presented by one or more of the devices that participated in the meeting). Furthermore, all content presented (i.e., every content item presented to one or more devices that participated in the meeting) may be presented simultaneously during playback of meeting recording 116. Each video stream associated with each device (if available) may also be presented simultaneously during playback of meeting recording 116.

Meeting recording 116 also provides functionality enabling the presentation of any primary video streams associated with a display. For example, meeting recording 116 may provide list of participants 124 such that list of participants 124 includes the primary video streams from each of displays 102-106. As previously described above, all primary video streams may be encoded and packaged as one composite primary video stream or as individual primary video streams. In either case, playback of any presented content may be in synchronization with a primary video stream. For example, presented content corresponding to timestamps 14:30-21:20 may be shown in synchronization with any primary video stream also corresponding to timestamps 14:30-21:20. In other words, any combination of presented content and primary video streams may be shown together in a synchronized manner.

In some embodiments, a relevance metric may be used to determine the initial presentation of content for meeting recording 116. That is, virtual meeting server 120 may determine a relevance metric for each of presented content 108-114. A relevance metric may be an integer value, a Boolean value (e.g., an “is_relevant” parameter may be set to True or False), or any suitable type of metric. Virtual meeting server 120 may determine which specific presented content of presented content 108-114 is to be considered the most relevant presented content. Virtual meeting server 120 may show an indication within meeting recording 116 to indicate the particular specific content that had the highest relevance metric. For example, in diagram 100, virtual meeting server 120 may determine that first presented content 108 has a relevance metric of 80, second presented content 110 has a relevance metric of 10, third presented content 112 has a relevance metric of 3, and fourth presented content has a relevance metric of 7. In some examples, each respective relevance metric may be indicative of the relevance with respect to the entire meeting duration. In other examples, the relevance metrics for each presented content may change over time and/or may be indicative of relevance with respect to a portion of the meeting duration. Based at least on first presented content 108 having the highest relevance metric out of presented content 108-114, first presented content 108 may be displayed larger in comparison to presented content 110-114. First presented content 108 may also be displayed with another indication to showcase that it has the highest relevance metric out of presented content 108-114. For example, first presented content 108 may be shown with a border, filter, higher resolution, or any other suitable indication to indicate that it has the highest relevance metric.

In some embodiments, if virtual meeting server 120 determines that first presented content 108 has the highest relevance metric out of presented content 108-114 and the respective relevance metrics are with respect to the entire meeting duration, then only first presented content 108 may be shown on meeting recording 116 upon initial playback. That is, presented content other than first presented content 108 may be hidden if first presented content 108 is determined to be the most relevant content with respect to the entire meeting.

In some embodiments, change content option 122 may also be shown on meeting recording 116. By selecting change content option 122, any of presented content 110-114 or any primary video stream may be presented. For example, only first presented content 108 may initially be shown in meeting recording 116. Change content option 122 may be selected, causing the generation of a display which allows any of presented content 110-114 to be presented. If third presented content 112 is selected, then third presented content 112 may be shown in meeting recording 116. Third presented content 112 may be presented in addition to or instead of first presented content 108. If third presented content 112 is presented in addition to first presented content 108, then both items of presented content may be resized (e.g., according to a preconfigured set of rules or according to received input).

In some embodiments, relevance metrics may be calculated for certain time frames during a virtual meeting, and meeting recording 116 may automatically show presented content which has the highest relevance metric for the corresponding time. For example, for a first time between timestamps 0:00-5:30, first presented content 108 may have the highest relevance metric out of any of presented content 108-114. As a result, meeting recording 116 may show first presented content 108 between timestamps 0:00-5:30 during playback. At a second time between timestamps 5:30-6:50, fourth presented content 114 may have the highest relevance metric out of any of presented content 108-114. As a result, meeting recording 116 may show fourth presented content 114 between timestamps 5:30-6:50 during playback. When fourth presented content 114 is shown during the second time, fourth presented content 114 may be show in place of or in addition to first presented content 108.

In some embodiments, different combinations of presented content may be shown simultaneously in meeting recording 116. During a first time (e.g., between timestamps 0:00-5:30), each of presented content 108-114 may be shown. When meeting recording 116 is being played back, any combination of presented content 108-114 may be shown simultaneously. For example, each of presented content 108-114 may be shown simultaneously, any combination of three items of presented content items from presented content 108-114 may be shown simultaneously, any combination of two items of presented content items from presented content 108-114 may be shown simultaneously, or any item of presented content from presented content 108-114 may be shown individually.

In some embodiments, if multiple items of presented content are shown, then one or more of the items of presented content may be resized. For example, third presented content 112 and first presented content 108 may be shown (e.g., as a result of selecting change content option 122 and then further selecting third presented content 112 to be shown in addition to first presented content 108). Meeting recording 116 enables third presented content 112 to be shown larger than first presented content 108 (e.g., according to a preconfigured set of rules or according to received input). Meeting recording 116 may also determine how large each presented content may be shown based on respective relevance metrics. For example, if during a specific time during playback the corresponding relevance metric of third presented content 112 is greater than the corresponding relevance metric of first presented content 108, then third presented content 112 may be shown larger with respect to first presented content 108.

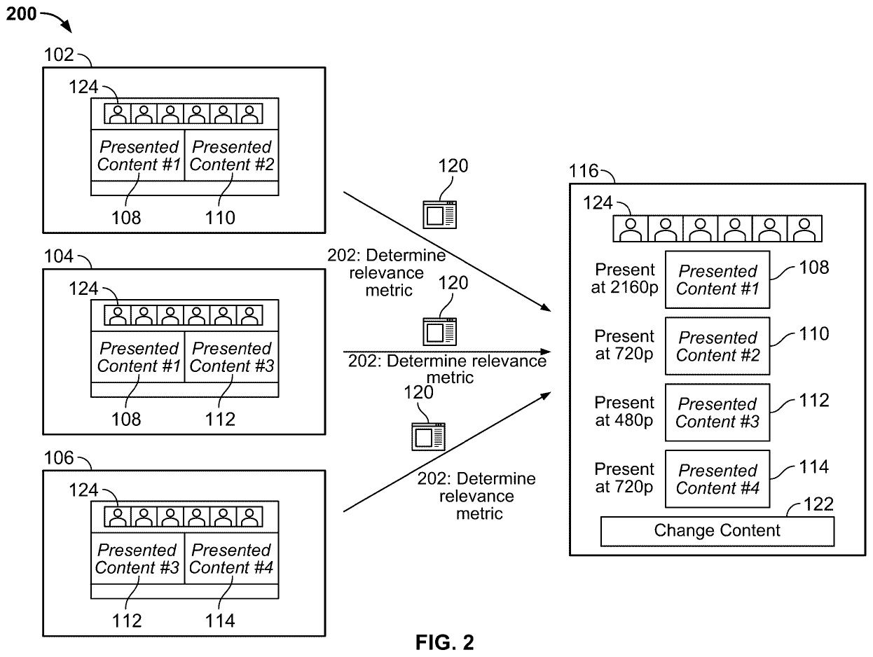

Furthermore, the resolution of presented content may be based at least in part on a determined relevance metric as further described below in connection with FIG. 2.

FIG. 2 is a diagram illustrating how presented content may be streamed at different resolutions, in accordance with some embodiments of this disclosure. The presented resolution of a particular presented content may be based on a respective relevance metric. In particular, presented content which virtual meeting server 120 determines to be more relevant (e.g., with respect to the entire meeting or with respect to a particular time period within the entire meeting) may be streamed at a higher resolution than other presented content as further described below.

In diagram 200, through process 202, virtual meeting server 120 may determine relevance metrics for each of presented content 108-114. For example, virtual meeting server 120 may determine that first presented content 108 has a relevance metric of “high relevance,” second presented content 110 has a relevance metric of “medium relevance,” third presented content 112 has a relevance metric of “low relevance,” and fourth presented content 114 has a relevance metric of “medium relevance.” As a result, in meeting recording 116, first presented content 108 may be presented in 2160p (or whatever highest resolution is available), second presented content 110 and fourth presented content 114 may be presented in 720p (or whatever second highest resolution is available), and third presented content 112 may be presented in 480p (or whatever third highest resolution is available). In diagram 200, each of presented content 108-114 is shown on meeting recording 204 at different resolutions based on its respective relevance metric.

In some embodiments, each of presented content 108-114 is stored based on each respective relevance metric. For example, if first presented content 108 is determined to be the most relevant content, then first presented content 108 may also be stored at the highest available resolution for later playback. If third presented content 112 is determined to be the least relevant content, then third presented content 112 may be stored at the lowest resolution for later playback.

In some embodiments, each of presented content 108-114 is stored at the highest available resolution, and/or may be stored or converted into multiple different resolutions in anticipation of transmission to a user viewing the meeting recording. For example, first presented content 108 and third presented content 112 may be determined to be the most relevant content and the least relevant content, respectively. Despite the differences in relevance, both first presented content 108 and third presented content 112 may be stored in the highest available resolution. Such embodiments enable content to be shown at different resolutions more easily as further described below.

In some embodiments, as previously described above in connection with FIG. 1, presented content 108-114 may be shown such that the most relevant presented content (e.g., first presented content 108) is shown in the highest available resolution and larger with respect to presented content considered to be less relevant. In such embodiments, change content option 122 enables any of presented content 110-114 to be shown in place of or in addition to first presented content 108. Each respective presented content may be shown at a respective resolution based on a respective relevance metric. That is, instead of presenting all of content 108-114 simultaneously, content may initially be presented serially. For example, if first presented content 108 is determined to have the highest relevance metric with respect to any of presented content 108-114, meeting recording 116 may initially only show first presented content 108 in the highest available resolution. If virtual meeting server 120 determines that second presented content 110 is to be shown (e.g., in addition to or in place of first presented content 108) via change content option 122, then, based on the respective relevance metric, second presented content 110 may be presented at the second highest resolution.

In some embodiments, each of presented content 108-114 may be shown at the same resolution, regardless of the respective relevance metric for each item of presented content. For example, each item of presented content 108-114 may be shown at the highest available resolution (e.g., 2160p). In another example, each item of presented content 108-114 may be shown in a resolution that is not the highest available resolution (e.g., 720p). In yet another example, each item of presented content 108-114 may be show in a lowest available resolution (e.g., 480p).

In some embodiments, change content option 122 enables each item of presented content 108-114 to be presented in different resolutions regardless of the respective relevance metric. For example, change content option 122 may enable third presented content 112 to be shown in the highest available resolution and first presented content 108 to be shown in the lowest available resolution, even if first presented content 108 is determined to be more relevant than third presented content 112.

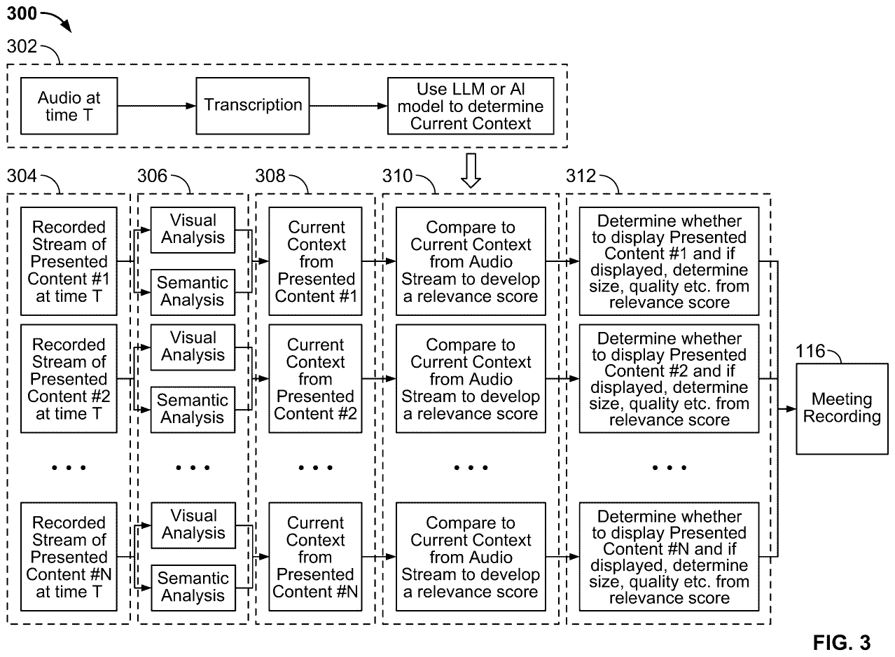

The manner in which relevance metrics are determined is further described below in connection with FIG. 3.

FIG. 3 is a diagram illustrating how relevance metrics may be determined, in accordance with some embodiments of the disclosure. In diagram 300, a global context is determined, and the context of a particular presented content is determined, in accordance with some embodiments of this disclosure. Virtual meeting server 120 (or any suitable computing medium) may compare the global and the particular content's contexts, and a relevance metric may be determined according to the comparison as further described below.

At 302, the audio at a particular time is transcribed. Automated transcription models may be used to perform the transcription of audio at a particular time. For example, automated speech recognition (ASR) may be used to perform the transcription. In another example, deep learning models such as convolutional neural networks (CNN), recurrent neural networks (RNN), or transformer models may be used to perform the transcription. Any other suitable procedure may be utilized to perform the audio transcription.

Further, at 302, a model may be used to determine a global context. The global context may be segmented into time sections such that a different global context is determined for different times, or the global context may be determined for the entire meeting. An artificial intelligence (AI) model may be used to determine the global context. For example, a large language model (LLM) or named entity recognition (NER) architecture may be used. The global context may be a textual summary of the audio at a particular time, a vectorized version of the transcription, or any suitable representation of the context of a meeting at a particular time or for the entire meeting duration.

At 304, each item of presented content shown during a virtual meeting is recorded. That is, each item of presented content is individually encoded and packaged. When each item of presented content is encoded, virtual meeting server 120 (or any other suitable computing medium) may also preprocess presented content for analysis at 306.

At 306, virtual meeting server 120 may conduct at least one of a visual or semantic analysis on each item of presented content. For example, performing a visual analysis may include utilizing a CNN to determine the substance of the presented content. In another example, performing a semantic analysis may include utilizing sentiment analysis, NER, or any suitable natural language processing (NLP) technique to determine the substance of the presented content. At 306, either both or only one of a visual and semantic analysis need be performed.

At 308, results from a virtual and/or semantic analysis from 306 are combined or incorporated together to produce an item which contains the context for a particular presented content. For example, a set of embeddings representing context for each respective item of presented content may be generated.

At 310, the context of a particular item of presented content and a global context is compared. For example, from 306-308, a vectorized set of embeddings representing the context corresponding to first presented content 108 may be compared to a vectorized set of embeddings representing a global context. To compare the different vectorized set of embeddings, cosine similarity, Euclidean distance, or any suitable comparison metric may be used. In another example, from 306-308, a textual summary representing the respective context for each item of presented content and a textual summary representing the global context may be generated. To compare the textual summaries, a Hamming distance, Levenshtein distance (e.g., based on the characters of the textual summaries), or any suitable comparison metric may be used. Moreover, an LLM may be used to perform the comparison between any suitable context representation of an item of presented content or a global context.

At 312, virtual meeting server 120 may determine parameters for each item of presented content to be set in meeting recording 314. For example, if virtual meeting server 120 determines that first presented content 108 has a greater cosine similarity with respect to the global context, then meeting recording 314 may be configured to show first presented content 108 with an indication that it has the greatest relevance metric out of any of presented content 108-114 (e.g., as previously described above in connection with FIG. 1), show first presented content 108 in a highest available resolution (e.g., as previously described above in connection with FIG. 2), or show first presented content 108 in any suitable manner of presentation.

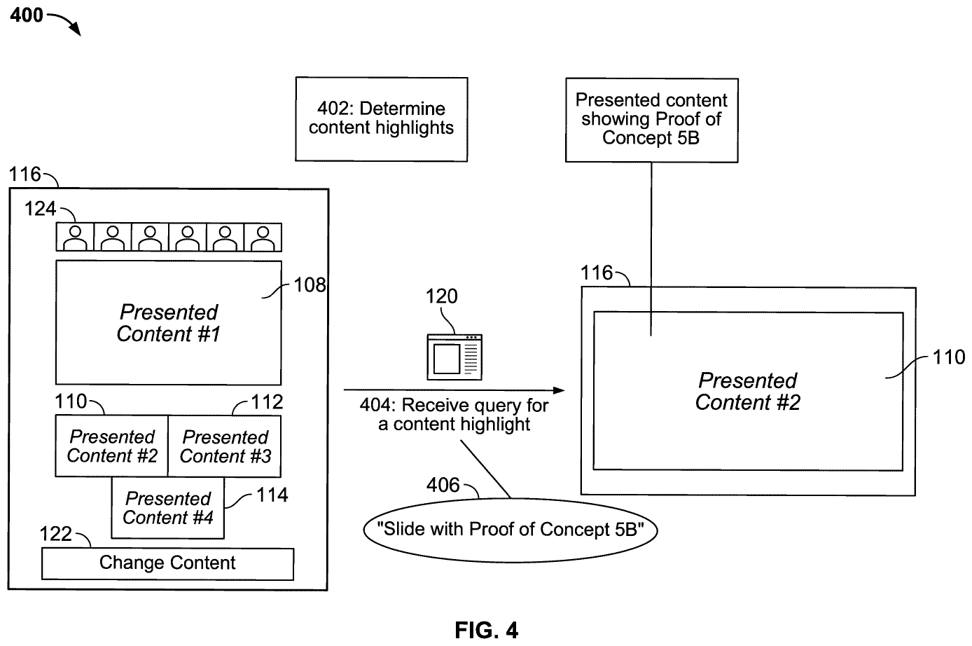

FIG. 4 is a diagram illustrating how a content highlight may be queried and shown in a meeting recording, in accordance with some embodiments of this disclosure. Different items of presented content may correspond to particular types of content or may show a particular highlight which may be of later interest.

For example, in diagram 400, a virtual meeting may be of an electrical engineering lecture. In diagram 400, first presented content 108 may correspond to a first set of lecture slides, and second presented content 110 may correspond to a second set of lecture slides. At a particular time, second presented content 110 may include specific content which may be of interest. For example, second presented content 110 may include a proof for a particular concept, but first presented content 108 may include a main set of lecture slides that is the primary content of interest. As a result, first presented content 108 may be the main content shown in meeting recording 116.

At 402, virtual meeting server 120 may perform an analysis to determine what aspects of particular content are to be considered a highlight. In some embodiments, virtual meeting server 120 may utilize a variety of deep learning or general AI approaches to determine what certain items of particular content may correspond to. For example, a deep learning model may determine that for some duration of the virtual meeting that second presented content 110 includes a proof for “Concept 5B,” and the deep learning model may further determine that Concept 5B corresponds to the linearity property of the Laplace transform. In some embodiments, virtual meeting server 120 may utilize an LLM to determine what content is to be considered a content highlight. In some embodiments, audio of the virtual meeting may be used to determine what presented content is to be considered a content highlight. For example, if some audio corresponds to a discussion related to the proof of the linearity property of the Laplace transform, then virtual meeting server 120 may perform an analysis to determine what segments of presented content may correspond to the linearity property of the Laplace transform.

At 404, virtual meeting server 120 may receive a query for a particular content highlight. The query may be received in different formats. For example, the query may be a textual input received from circuitry coupled to a display showing any of presented content 108-114. In another example, the query may be a voice-based input. The voice-based input may be received from an application or device external from the virtual meeting managed by virtual meeting server 120. In diagram 400, query 406 may be received by virtual meeting server 120. Query 406 may be “Slide with Proof of Concept 5B.”

At 404, once query 406 is received, virtual meeting server 120 determines what presented content best matches query 406 and causes the corresponding content to be presented. As previously described above, second presented content 110 may include the proof for Concept 5B and therefore be shown on meeting recording 116.

In some embodiments, related content may be shown in place of the received query. For example, as previously described above, Concept 5B may correspond to a proof of the linearity property of the Laplace transform. As such, at 404, if the received query says, “Linearity property of Laplace transform,” virtual meeting server 120 may determine that presented content related to Concept 5B should be shown.

In some embodiments, multiple matches for queried content may be determined. In such embodiments, meeting recording 116 may provide any presented content which may match the received query. For example, if a query for proof of Concept 5A is received by virtual meeting server 120, and the proof for Concept 5A is shown in both third presented content 112 and fourth presented content 114, then virtual meeting server 120 may cause meeting recording 116 to show both third presented content 112 and fourth presented content 114 for selection. Both third presented content 112 and fourth presented content 114 may be (simultaneously) displayed in addition to or in place of whatever content was previously being shown in meeting recording 116. Alternatively, only one of third presented content 112 and fourth presented content 114 may be presented in addition to or in place of whatever content was previously being shown in meeting recording 116.

In some embodiments, virtual meeting server 120 may determine that there are no smatches for a received query. In such embodiments, virtual meeting server 120 may cause an indication to be presented that no matches were found on the display corresponding to meeting recording 116. For example, text saying “Sorry, no matches were found” may be shown. In such embodiments, suggestions for possible related queries may be shown. Possible related queries may be corrections to possible typos in the received query or may be other similar queries. For example, if the received query is “Show pierhfeif for Concept 5B,” meeting recording 116 may show an option saying, “Did you mean: ‘Show proof of Concept 5B’?” In such an example, selecting the option saying, “Did you mean: ‘Show proof of Concept 5B’?” may result in whatever presented content related to Concept 5B to be presented in addition to or in place of whatever content was previously presented in meeting recording 116. In another example, the received query may be “Show proof for Concept 5C.” If no highlight is determined to be related to Concept 5C (e.g., if Concept 5C was never mentioned or shown in any capacity during the virtual meeting), then meeting recording 116 may show two options saying, “Did you mean: ‘Show proof for Concept 5A’?” and “Did you mean: ‘Show proof for Concept 5B’?” In such an example, one of the presented options may be selected, and the presented content corresponding to the selection option may be shown.

In some embodiments, the resolution of the queried content may be the same or varied. If queried content corresponds to present content having a lower relevance metric, then meeting recording 116 may still show whatever content corresponds to the queried content in the highest resolution. Alternatively, if whatever content corresponding to the queried content corresponds to a low relevance metric, then meeting recording 116 may show whatever content corresponds to the queried content in a low resolution.

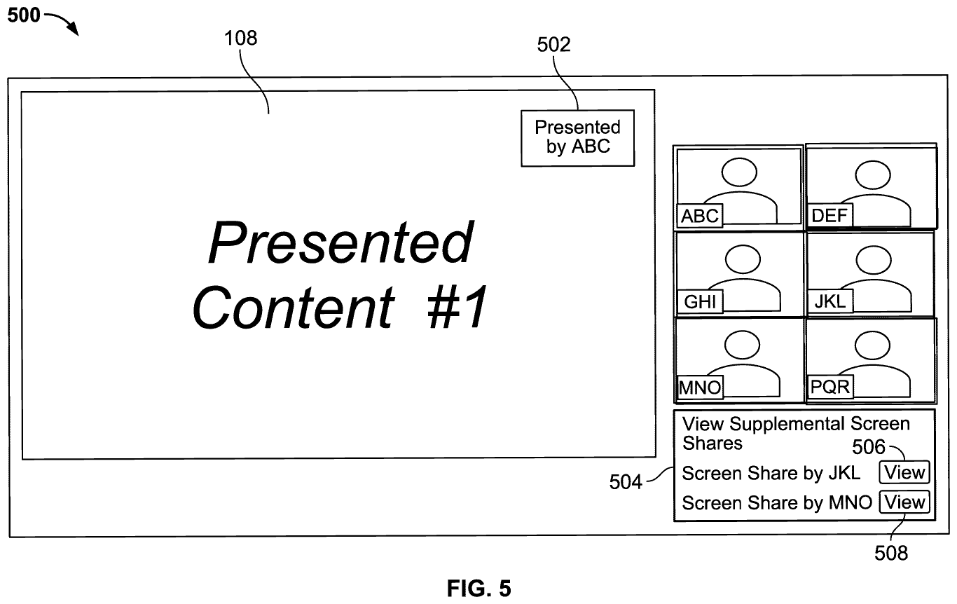

FIG. 5 is an example virtual meeting where some presented content may be considered supplemental, in accordance with some embodiments of the disclosure. During the live virtual meeting, presented content may be considered as mandatory (hereafter referred to as mandatory content) or supplemental (hereafter referred to as supplemental content). Depending on whether content is mandatory content or supplemental content, content may be shown differently as further described below.

In virtual meeting 500, first presented content 108 may be mandatory content. Based on first presented content 108 being considered mandatory, indication 502 may be shown on a given display to indicate the origin of first presented content 108. In some embodiments, mandatory content may be based on whether the content originates from a meeting host. In some embodiments, mandatory content may be based on a preconfigured setting. For example, virtual meeting server 120 may have received an input prior to the virtual meeting starting that indicates what content is to be considered mandatory content. In some embodiments, a live analysis software may be used to determine what presented content is mandatory content. For example, virtual meeting server 120 may run an analysis which uses an LLM to determine what presented content should be considered mandatory content.

In virtual meeting 500, only first presented content 108 is considered mandatory. Based on only first presented content 108 being considered mandatory, all other presented content may be considered supplemental. Supplemental content may be determined according to a predetermined set of rules (e.g., rules that specify that only content presented by the host is mandatory content), a live analysis software, or any other suitable decision-making process.

In some embodiments, supplemental content may be shown in addition to or in place of mandatory content. Supplemental content may be itemized in window 504. In such embodiments, view option 506 or 508 may be selected. Upon the selection of both or either option 506 or 508, the respective presented content (which is supplemental content) may be shown in addition to or in place of first presented content 108 (which is mandatory content).

In some embodiments, when option 506 or 508 is selected, a warning indication may be shown indicating that the currently shown presented content is mandatory content. The indication may be ignored (e.g., by selecting an option to remove the indication or selecting an option indicating that the warning is acknowledged).

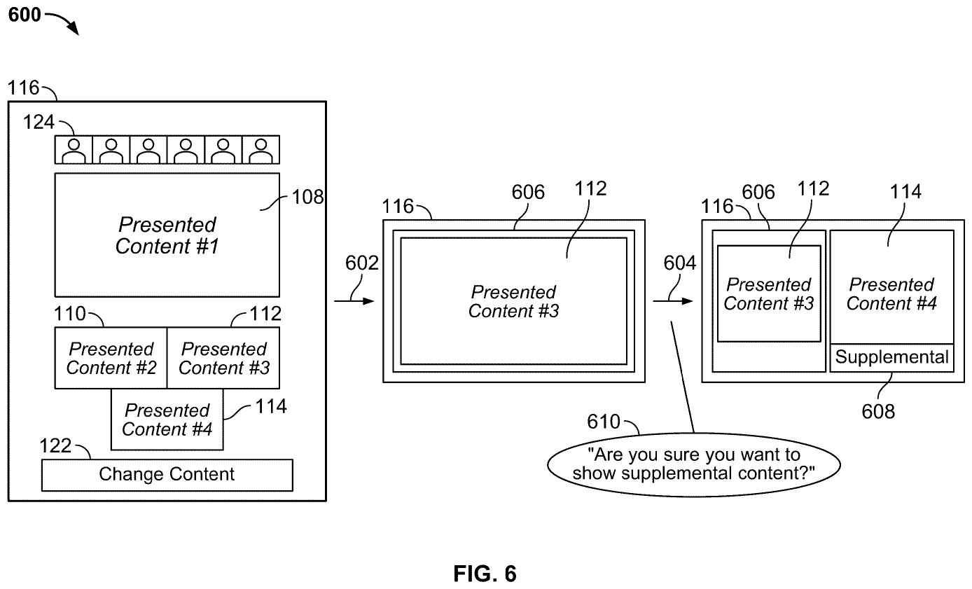

Each item of presented content may be individually packaged and encoded. The generated meeting recording may enable viewership of any presented content, regardless of whether the presented content is mandatory content or supplemental content, as further described below in connection with FIG. 6.

FIG. 6 is a diagram illustrating how presented content is shown in a meeting recording depending on whether the presented content is mandatory or supplemental, in accordance with some embodiments of the disclosure. During a particular time, certain presented content may be considered mandatory whereas other presented content may be considered supplemental. For example, certain content presented on display 102 may be considered mandatory if virtual meeting server 120 determines that display 102 corresponds to the meeting host display. Other content may be considered supplemental for various reasons, such as if a threshold number of presented content items are already being shared during a virtual meeting. Meeting recording 116 enables viewership of mandatory and supplemental presented content, but mandatory content may be presented with one or more indications as further described below.

In diagram 600, meeting recording 116 may initially show each of presented content 108-114 with change content option 122. At a particular time during the live virtual meeting, third presented content 112 may be determined to be mandatory. At 602, during playback of meeting recording 116, third presented content 112 may be shown at the time at which third presented content 112 is determined to be mandatory. At 604, meeting recording 116 may receive an instruction to show fourth presented content 114 at the same time while third presented content 112 is also considered mandatory. Thus, third presented content 112 is shown with indication 606 and fourth presented content 114 is also shown.

For example, during the live virtual meeting from timestamps 3:20-10:30, third presented content 112 may be considered mandatory. As a result, when meeting recording 116 plays the virtual meeting from 3:20-10:30, third presented content 112 is presented with indication 606 to indicate that it is considered mandatory.

While indication 606 is shown to be a border in FIG. 6, any suitable indication may also be used to show that third presented content 112 is considered mandatory during a certain time. For example, third presented content 112 may be shown larger in comparison to fourth presented content 114.

In some embodiments, supplemental content may be shown with an indication in addition to mandatory content. For example, third presented content 112 may be shown as mandatory with indication 606, and fourth presented content 114 may be shown with indication 608 with text indicating that fourth presented content 114 is supplemental. Indication 608 may also be a border (e.g., similar to indication 606). Indication 608 need not be an indication, per se. For example, fourth presented content 114 may be displayed smaller in comparison to third presented content 112.

In some embodiments, presented content considered to be supplemental may be shown entirely in place of presented content considered to be mandatory. In such embodiments, indication 610 may be shown in meeting recording 116 with an option saying, “Are you sure you want to show supplemental content?” Indication 610 may provide an option not to proceed and show presented content considered to be mandatory in meeting recording 116. Indication 610 may provide an option to procced. If the option to proceed is selected, then meeting recording 116 may be configured to show only presented content considered to be supplemental or show both presented content considered to be supplemental and considered to be mandatory. Moreover, presented content considered to be supplemental and mandatory may each also be shown with indicators 608 and 606, respectively.

In some embodiments, mandatory content and supplemental content may dynamically switch being shown on meeting recording 116. For example, fourth presented content 114 may be determined to, at a later time, be considered mandatory. If at the same later time third presented content 112 is determined to be supplemental, then meeting recording 116 may dynamically switch how fourth presented content 114 and how third presented content 112 are shown. That is, fourth presented content 114 may be shown as mandatory (e.g., with indication 606) and third presented content 112 may be shown as supplemental (e.g., with indication 608) without any external input.

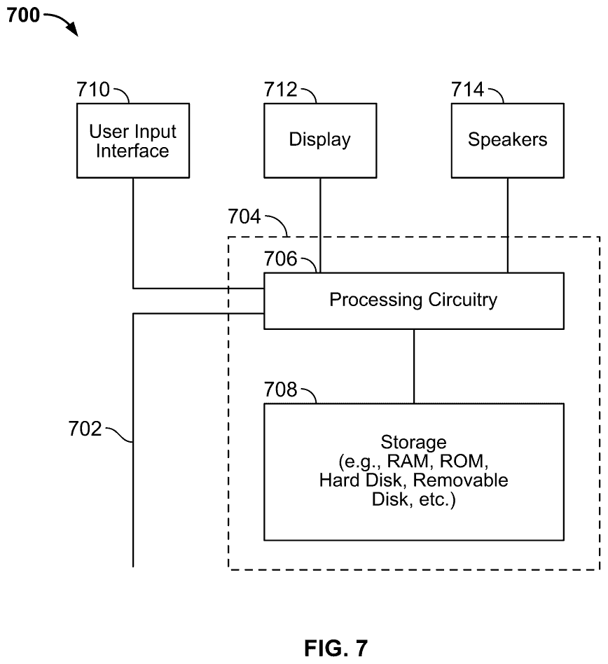

FIG. 7 is a block diagram of an illustrative user equipment (UE) device, in accordance with some embodiments of the disclosure.

Any of presented content 108-114 or meeting recording 116 (and its displays described above and below) may be accessed from one or more of their user equipment devices. FIG. 6 shows a generalized embodiment of illustrative user equipment device 700. User equipment device 700 may receive content and data via input/output (hereinafter “I/O”) path 702. I/O path 702 may provide content (e.g., broadcast programming, on-demand programming. Internet content, content available over a local area network (LAN) or wide area network (WAN), and/or other content) and data to control circuitry 704, which includes processing circuitry 706 and storage 708. Control circuitry 704 may be used to send and receive commands, requests, and other suitable data using I/O path 702. I/O path 702 may connect control circuitry 704 (and specifically processing circuitry 706) to one or more communications paths (described below). I/O functions may be provided by one or more of these communications paths but are shown as a single path in FIG. 6 to avoid overcomplicating the drawing.

Control circuitry 704 may be based on any suitable processing circuitry such as processing circuitry 706. As referred to herein, processing circuitry should be understood to mean circuitry based on one or more microprocessors. microcontrollers, digital signal processors, programmable logic devices, field-programmable gate arrays (FPGAs), application-specific integrated circuits (ASICs), etc. and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 704 executes instructions for a meeting recording application stored in memory (i.e., storage 708). Specifically, control circuitry 704 may be instructed by the meeting recording application to perform the functions discussed above and below. For example, the meeting recording application may provide instructions to control circuitry 704 to generate the displays illustrated in the figures and described herein. In some implementations, any action performed by control circuitry 704 may be based on instructions received from the meeting recording application.

In client-server based embodiments, control circuitry 704 may include communications circuitry suitable for communicating with a meeting recording application server or other networks or servers. The instructions for carrying out the above-mentioned functionality may be stored on the meeting recording application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of user equipment devices, or communication of user equipment devices in locations remote from each other (described in more detail below).

Memory may be an electronic storage device provided as storage 708 that is part of control circuitry 704. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders. BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 708 may be used to store various types of content described herein as well as meeting recording data described above. Nonvolatile memory may also be used (e.g., to launch a boot-up routine and other instructions). Cloud-based storage may be used to supplement storage 708 or instead of storage 708.

Control circuitry 704 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 704 may also include scaler circuitry for upconverting and downconverting content into the preferred output format of the user equipment 700. Circuitry 704 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive meeting recording data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 708 is provided as a separate device from user equipment 700, the tuning and encoding circuitry (including multiple tuners) may be associated with storage 708.

Instructions may be received by control circuitry 704 using user input interface 710. User input interface 710 may be any suitable user interface, such as a remote control, mouse, trackball, keypad, keyboard, touch screen, touchpad, stylus input, joystick, voice recognition interface, or other user input interfaces. Display 712 may be provided as a stand-alone device or integrated with other elements of user equipment device 700. For example, display 712 may be a touchscreen or touch-sensitive display. In such circumstances, user input interface 710 may be integrated with or combined with display 712. Display 712 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 712 may be HDTV-capable. In some embodiments, display 712 may be a 3D display, and the meeting recording application and any suitable content may be displayed in 3D. A video card or graphics card may generate the output to the display 712. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 704. The video card may be integrated with the control circuitry 704. Speakers 714 may be provided as integrated with other elements of user equipment device 700 or may be stand-alone units. The audio component of videos and other content displayed on display 712 may be played through speakers 714. In some embodiments, the audio may be distributed to a receiver (not shown), which processes and outputs the audio via speakers 714.

The meeting recording application may be implemented using any suitable architecture. For example, it may be a stand-alone application wholly implemented on user equipment device 700. In such an approach, instructions of the application are stored locally (e.g., in storage 708), and data for use by the application is downloaded on a periodic basis (e.g., from an out-of-band feed, from an Internet resource, or using another suitable approach). Control circuitry 704 may retrieve instructions of the application from storage 708 and process the instructions to generate any of the displays discussed herein. Based on the processed instructions, control circuitry 704 may determine what action to perform when input is received from input interface 710. For example, movement of a cursor on a display up/down may be indicated by the processed instructions when input interface 710 indicates that an up/down button was selected.

In some embodiments, the meeting recording application is a client-server based application. Data for use by a thick or thin client implemented on user equipment device 700 is retrieved on-demand by issuing requests to a server remote to the user equipment device 700. In one example of a client-server based meeting recording application, control circuitry 704 runs a web browser that interprets web pages provided by a remote server. For example, the remote server may store the instructions for the application in a storage device. The remote server may process the stored instructions using circuitry (e.g., control circuitry 704) and generate the displays discussed above and below. The client device may receive the displays generated by the remote server and may display the content of the displays locally on equipment device 700. This way, the processing of the instructions is performed remotely by the server while the resulting displays are provided locally on equipment device 700. Equipment device 700 may receive inputs from the user via input interface 710 and transmit those inputs to the remote server for processing and generating the corresponding displays. For example, equipment device 700 may transmit a communication to the remote server indicating that an up/down button was selected via input interface 710. The remote server may process instructions in accordance with that input and generate a display of the application corresponding to the input (e.g., a display that moves a cursor up/down). The generated display is then transmitted to equipment device 700 for presentation to the user.

In some embodiments, the meeting recording application is downloaded and interpreted or otherwise run by an interpreter or virtual machine (run by control circuitry 704). In some embodiments, the meeting recording application may be encoded in the ETV Binary Interchange Format (EBIF), received by control circuitry 704 as part of a suitable feed, and interpreted by a user agent running on control circuitry 704. For example, the meeting recording application may be an EBIF application. In some embodiments, the meeting recording application may be defined by a series of JAVA-based files that are received and run by a local virtual machine or other suitable middleware executed by control circuitry 704. In some of such embodiments (e.g., those employing MPEG-2 or other digital media encoding schemes), the meeting recording application may be, for example, encoded and transmitted in an MPEG-2 object carousel with the MPEG audio and video packets of a program.

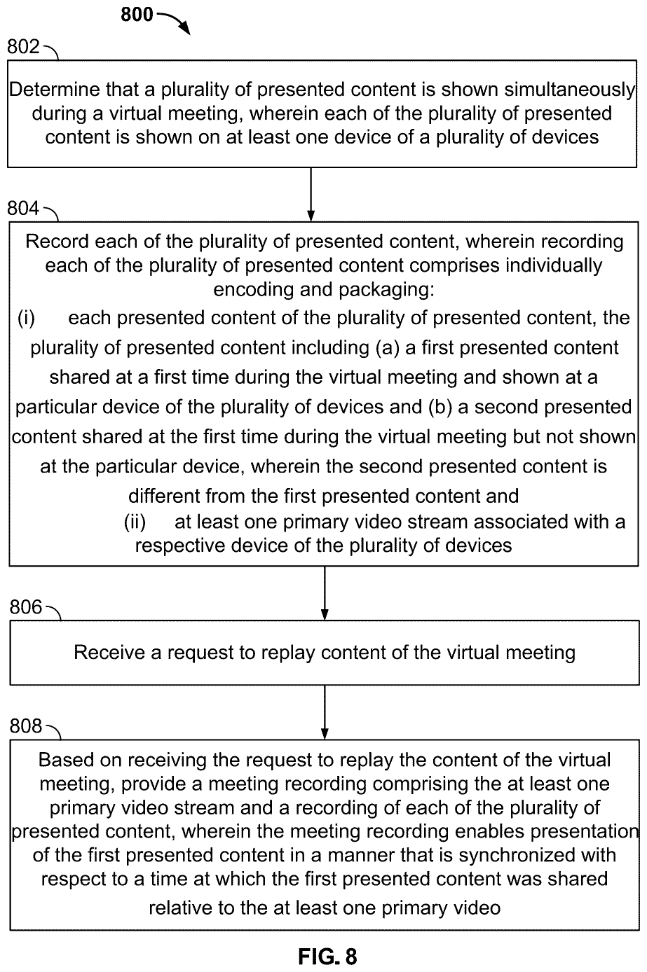

FIG. 8 is a flow diagram of a method for generating a meeting recording which enables the presentation of any presented content which was shared to at least one display during a virtual meeting, in accordance with some embodiments of this disclosure.

At 802, a virtual meeting server (e.g., virtual meeting server 120) determines that a plurality of presented content is shown simultaneously during a virtual meeting such that each of the plurality of presented content is shown on at least one device of a plurality of devices.

At 804, the virtual meeting server may record each of the plurality of presented content such that recording each of the plurality of presented content includes individually encoding and packaging each presented content of the plurality of presented content and at least one primary video stream associated with a respective device of the plurality of devices. The plurality of presented content includes a first presented content shared at a first time during the virtual meeting and shown at a particular device of the plurality of devices. The plurality of presented content also includes a second presented content shared at the particular device such that the second presented content is different from the first presented content.

At 806, the virtual meeting server may receive a request to replay content of the virtual meeting.

At 808, the virtual meeting server may, based on receiving the request to replay the content of the virtual meeting, provide a meeting recording including the at least one primary video stream and a recording of each of the plurality of presented content. The meeting recording enables presentation of the first presented content in a manner that is synchronized with respect to a time at which the first presented content was shared relative to the at least one primary video.

In some embodiments, the virtual meeting server may determine, for each of the plurality of presented content, a respective relevance metric. The virtual meeting server may further determine a most relevant presented content of the plurality of presented content based on the respective relevance metrics and may show within the meeting recording, an indication that the most relevant presented content has a highest relevance metric.

In some embodiments, the virtual meeting server may determine, for each of the plurality of presented content, a respective relevance metric. The virtual meeting server may stream each of the plurality of presented content at a respective quality based at least in part on the respective relevance metric corresponding to the respective presented content.

In some embodiments, the virtual meeting server may determine, for each of the plurality of presented content, a respective relevance metric, such that each relevance metric is determined by one or more of the following steps in no particular order: the virtual meeting server may perform, for a second time, at least one of a visual analysis or a semantic analysis for a particular presented content; the virtual meeting server may, based at least in part on the at least one of the visual analysis or the semantic analysis, determine a first context corresponding to the particular presented content; the virtual meeting server may determine a second context for the second time during the virtual meeting, such that the second context is based at least in part on an audio corresponding to the second time; and the virtual meeting server may compare the first context to the second context.

In some embodiments, the virtual meeting server may initiate playback of the meeting recording. The virtual meeting server may further show a third presented content of the meeting recording during a second time such that a first relevance metric corresponding to the third presented content at the second time is greater than a second relevance metric corresponding to a fourth presented content at the second time. The virtual meeting server may further determine during a third time that a third relevance metric corresponding to the third presented content at the third time is less than a fourth relevance metric corresponding to the fourth presented content at the third time and may cause the fourth presented content to be shown.

In some embodiments, the virtual meeting server may determine a content highlight for a particular presented content of the plurality of presented content, may receive a query indicating to show the particular presented content corresponding to the content highlight, and may show the particular presented content.

In some embodiments, the virtual meeting server may determine that a third presented content of the plurality of presented content is being shared and shown during a first time. The meeting recording enables presentation of any of the following: the first presented content and the second presented content simultaneously, the first presented content and the third presented content simultaneously, the second presented content and the third presented content simultaneously, or the first presented content, the second presented content, and the third presented content simultaneously.

In some embodiments, the virtual meeting server may initiate playback of the meeting recording and may cause a third presented content to be shown such that the causing is based at least in part on a relevance metric corresponding to the third presented content. The virtual meeting server may further receive an instruction to cause a fourth presented content to be shown such that the fourth presented content has a corresponding relevance metric that is less than the relevance metric corresponding to the third presented content. Based on the instruction, the virtual meeting server may further cause the fourth presented content to be shown.

In some embodiments, the virtual meeting server determines that a third presented content is mandatory at a second time. The virtual meeting server may determine that a fourth presented content is supplemental at the second time and may cause, during viewing of the meeting recording, the third presented content to be shown with a first indication that the third presented content is mandatory.

In such embodiments, the virtual meeting server may receive an instruction to display the fourth presented content during the second time and may cause the fourth presented content to be shown with a second indication that the fourth presented content is supplemental while simultaneously showing the third presented content with the first indication that the third presented content is mandatory.

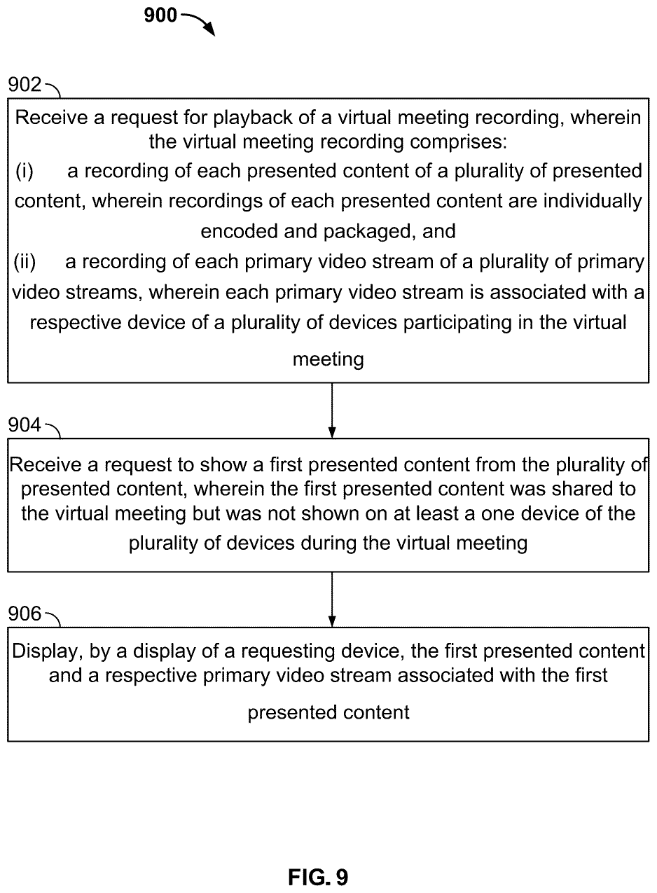

FIG. 9 is a flow diagram of a method for viewing a virtual meeting which enables the synchronous playback of any presented content and any primary video stream, in accordance with some embodiments of this disclosure.

At 902, a client device may receive a request for playback of a virtual meeting recording. The virtual meeting includes at least a recording of each presented content of a plurality of presented content and a recording of each primary video stream of a plurality of primary video streams. The recordings of each presented content are individually encoded and packaged. The primary video stream is associated with a respective device of a plurality of devices participating in the virtual meeting.

In some embodiments, each primary video is individually packaged and encoded. In some embodiments, the plurality of primary video streams is packaged and encoded as a composite primary video stream recording.

At 904, the client device may receive a request to show a first presented content from the plurality of presented content, wherein the first presented content was shared to the virtual meeting but was not shown on at least a one device of the plurality of devices during the virtual meeting.

At 906, the client device may display, by a display of the requesting device, the first presented content and a respective primary video stream associated with the first presented content.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for presenting previously recorded content, the method comprising:
determining that a plurality of presented content is shown simultaneously during a virtual meeting, wherein each of the plurality of presented content is shown on at least one device of a plurality of devices;
recording each of the plurality of presented content, wherein recording each of the plurality of presented content comprises individually encoding and packaging:
(i) each presented content of the plurality of presented content, the plurality of presented content including (a) a first presented content shared at a first time during the virtual meeting and shown at a particular device of the plurality of devices and (b) a second presented content shared at the first time during the virtual meeting but not shown at the particular device, wherein the second presented content is different from the first presented content; and
(ii) at least one primary video stream associated with a respective device of the plurality of devices;
receiving a request to replay content of the virtual meeting;
based on receiving the request to replay the content of the virtual meeting, providing a meeting recording comprising the at least one primary video stream and a recording of each of the plurality of presented content, wherein the meeting recording enables presentation of the first presented content in a manner that is synchronized with respect to a time at which the first presented content was shared relative to the at least one primary video stream.

2. The method of claim 1, further comprising:
determining, for each of the plurality of presented content, a respective relevance metric;
determining a most relevant presented content of the plurality of presented content based on the respective relevance metrics; and
showing, within the meeting recording, an indication that the most relevant presented content has a highest relevance metric.

3. The method of claim 1, further comprising:
determining, for each of the plurality of presented content, a respective relevance metric; and
streaming each of the plurality of presented content at a respective quality based at least in part on the respective relevance metric corresponding to the respective presented content.

4. The method of claim 1 further comprising:
determining, for each of the plurality of presented content, a respective relevance metric, wherein each relevance metric is determined by:
performing, for a second time, at least one of a visual analysis or a semantic analysis for a particular presented content;
based at least in part on the at least one of the visual analysis or the semantic analysis, determining a first context corresponding to the particular presented content;
determining a second context for the second time during the virtual meeting, wherein the second context is based at least in part on an audio corresponding to the second time; and
comparing the first context to the second context.

5. The method of claim 1 further comprising:
initiating playback of the meeting recording;
showing a third presented content of the meeting recording during a second time, wherein:
a first relevance metric corresponding to the third presented content at the second time is greater than a second relevance metric corresponding to a fourth presented content at the second time;
determining during a third time that a third relevance metric corresponding to the third presented content at the third time is less than a fourth relevance metric corresponding to the fourth presented content at the third time; and
causing the fourth presented content to be shown.

6. The method of claim 1, further comprising:
determining a content highlight for a particular presented content of the plurality of presented content;
receiving a query indicating to show the particular presented content corresponding to the content highlight; and
showing the particular presented content.

7. The method of claim 1, further comprising:
determining that the second presented content and a third presented content of the plurality of presented content are being shared and shown to at least one device of the plurality of devices,
wherein the meeting recording enables presentation of any of:
the first presented content and the second presented content simultaneously,
the first presented content and the third presented content simultaneously,
the second presented content and the third presented content simultaneously, or
the first presented content, the second presented content, and the third presented content simultaneously.

8. The method of claim 1, further comprising:
initiating playback of the meeting recording;
causing a third presented content to be shown, wherein the causing is based at least in part on a relevance metric corresponding to the third presented content;
receiving an instruction to cause a fourth presented content to be shown, wherein the fourth presented content has a corresponding relevance metric that is less than the relevance metric corresponding to the third presented content; and
based on the instruction, causing the fourth presented content to be shown.

9. The method of claim 1, further comprising:
determining that a third presented content is mandatory at a second time;
determining that a fourth presented content is supplemental at the second time; and
causing, during viewing of the meeting recording, the third presented content to be shown with a first indication that the third presented content is mandatory.

10. The method of claim 9, further comprising:
receiving an instruction to display the fourth presented content during the second time; and
causing the fourth presented content to be shown with a second indication that the fourth presented content is supplemental while simultaneously showing the third presented content with the first indication that the third presented content is mandatory.

11. A method for reviewing a virtual meeting, the method comprising:
receiving a request for playback of a virtual meeting recording, wherein the virtual meeting recording comprises:
(i) a recording of each presented content of a plurality of presented content, wherein recordings of each presented content are individually encoded and packaged, and
(ii) a recording of each primary video stream of a plurality of primary video streams, wherein each primary video stream is associated with a respective device of a plurality of devices participating in the virtual meeting,
receiving a request to show a first presented content from the plurality of presented content, wherein the first presented content was shared to the virtual meeting but was not shown on at least a one device of the plurality of devices during the virtual meeting; and
displaying, by a display of a requesting device, the first presented content and a respective primary video stream associated with the first presented content.

12. The method of claim 11, wherein each primary video is individually packaged and encoded.

13. The method of claim 11, wherein the plurality of primary video streams is packaged and encoded as a composite primary video stream recording.

14. A system for presenting previously recorded content, comprising memory and control circuitry configured to:
determine that a plurality of presented content is shown simultaneously during a virtual meeting, wherein each of the plurality of presented content is shown on at least one device of a plurality of devices;
record each of the plurality of presented content, wherein recording each of the plurality of presented content comprises individually encoding and packaging:
(i) each presented content of the plurality of presented content, the plurality of presented content including (a) a first presented content shared at a first time during the virtual meeting and shown at a particular device of the plurality of devices and (b) a second presented content shared at the first time during the virtual meeting but not shown at the particular device, wherein the second presented content is different from the first presented content; and
(ii) at least one primary video stream associated with a respective device of the plurality of devices;
receive a request to replay content of the virtual meeting;
based on receiving the request to replay the content of the virtual meeting, provide a meeting recording comprising the at least one primary video stream and a recording of each of the plurality of presented content, wherein the meeting recording enables presentation of the first presented content in a manner that is synchronized with respect to a time at which the first presented content was shared relative to the at least one primary video stream.

15. The system of claim 14, wherein the control circuitry is further configured to:
determine, for each of the plurality of presented content, a respective relevance metric;
determine a most relevant presented content of the plurality of presented content based on the respective relevance metrics; and
show, within the meeting recording, an indication that the most relevant presented content has a highest relevance metric.

16. The system of claim 14, wherein the control circuitry is further configured to:
determine, for each of the plurality of presented content, a respective relevance metric; and
stream each of the plurality of presented content at a respective quality based at least in part on the respective relevance metric corresponding to the respective presented content.

17. The system of claim 14, wherein the control circuitry is further configured to:
determine, for each of the plurality of presented content, a respective relevance metric, wherein each relevance metric is determined by:
performing, for a second time, at least one of a visual analysis or a semantic analysis for a particular presented content;
based at least in part on the at least one of the visual analysis or the semantic analysis, determining a first context corresponding to the particular presented content;
determining a second context for the second time during the virtual meeting, wherein the second context is based at least in part on an audio corresponding to the second time; and
comparing the first context to the second context.

18. The system of claim 14, wherein the control circuitry is further configured to:
initiate playback of the meeting recording;
show a third presented content of the meeting recording during a second time, wherein:
a first relevance metric corresponding to the third presented content at the second time is greater than a second relevance metric corresponding to a fourth presented content at the second time;
determine during a third time that a third relevance metric corresponding to the third presented content at the third time is less than a fourth relevance metric corresponding to the fourth presented content at the third time; and
cause the fourth presented content to be shown.

19. The system of claim 14, wherein the control circuitry is further configured to:
determine a content highlight for a particular presented content of the plurality of presented content;
receive a query indicating to show the particular presented content corresponding to the content highlight; and
show the particular presented content.

20. The system of claim 14, wherein the control circuitry is further configured to:
determine that the second presented content and a third presented content of the plurality of presented content are being shared and shown to at least one device of the plurality of devices,
wherein the meeting recording enables presentation of any of:
the first presented content and the second presented content simultaneously,
the first presented content and the third presented content simultaneously,
the second presented content and the third presented content simultaneously, or
the first presented content, the second presented content, and the third presented content simultaneously.

21-65. (canceled)
